(19) United States
(12) Patent Application Publication
(10) Pub. No.: US 2021/0388714 A1
(43) Pub. Date: Dec. 16, 2021

(54) FORECASTING HYDROCARBON RESERVOIR PROPERTIES WITH ARTIFICIAL INTELLIGENCE

(71) Applicant: Saudi Arabian Oil Company, Dhahran (SA)

(72) Inventors: Klemens Katterbauer, Dhahran (SA); Alberto F. Marsala, Dhahran (SA)

(73) Assignee: Saudi Arabian Oil Company, Dhahran (SA)

(21) Appl. No.: 16/897,619

(22) Filed: Jun. 10, 2020

(51) Int. Cl. E21B 47/04; G06N 3/08; G06N 3/04; G06N 5/04

(52) U.S. Cl. CPC E21B 47/04; G06N 5/046; G06N 3/0454; G06N 3/08

(57) ABSTRACT

Systems, methods, and apparatus including computer-readable mediums for forecasting hydrocarbon reservoir properties such as well log responses and petrophysical parameters using artificial intelligence are provided. In one aspect, a method of forecasting well logs of a target well includes obtaining well data of the target well including depth and geological information and reservoir parameters and estimating jointly multiple well logs of the target well by utilizing an artificial intelligence (AI) network with the well data of the target well. The AI network is trained based on well data of existing wells that includes multiple reservoir parameters of the existing wells jointly as inputs and multiple well logs of the existing wells jointly as outputs. The estimated multiple well logs of the target well are reconciled with each other, with the well logs of the existing wells, and with geographic formation associated with the target well and the existing wells.

### TECHNICAL FIELD

This specification relates to hydrocarbon reservoir properties, particularly to well log responses and petrophysical parameters.

### BACKGROUND

A hydrocarbon reservoir is a heterogeneous geological system with large intrinsic complexity. Reservoir porosity, permeability and hydrocarbon saturation are directly related to the storage capacity, fluid flow capacity and amount of hydrocarbon pore volume respectively. Problems related to reservoir characterization are difficult due to natural heterogeneity, uncertainty and nonlinearity in these reservoir parameters. Consequently, it is typically difficult to explicitly quantify variable reservoir properties.

A well log is a detailed record of geologic formations penetrated by a borehole. The well log may be based either on visual inspection of samples brought to the surface (geological logs) or on physical measurements made by instruments lowered into the hole (geophysical logs). Some types of geophysical well logs can be done during any phase of a well's history: drilling, completing, producing, or abandoning. The geophysical/geomechanical studies of the well logs can be used to determine hydrocarbons presence, determination of fluid type-gas, oil, water, bitumen, computation of porosity, computation of water saturation and lithology. However, drilling wells and obtaining a number of well logs are expensive and time consuming, with uncertainty of whether the drilled wells are not low productive. Thus, it is desirable to accurately estimate well log responses and/or reservoir properties before wells are drilled or formed.

### SUMMARY

The present specification describes methods and systems for forecasting hydrocarbon reservoir properties, e.g., well log responses and/or petrophysical parameters, with artificial intelligence (AI), e.g., using artificial neural networks (ANNs).

One aspect of the present disclosure features a method of forecasting well logs of a target well including: obtaining well data of the target well by a computing system, the well data including depth and geological information and multiple reservoir parameters; and estimating jointly multiple well logs of the target well by the computing system utilizing an artificial intelligence (AI) network with the well data of the target well, the AI network being trained based on well data of existing wells that includes multiple reservoir parameters of the existing wells jointly as inputs of the AI network and multiple well logs of the existing wells jointly as outputs of the AI network, the estimated multiple well logs of the target well being reconciled with each other. The estimated multiple well logs of the target well can be reconciled with the multiple well logs of the existing wells and geographic formation associated with the target well and the existing wells.

The method can further include processing the well data of the target well to be conformed with the well data of the existing wells. Processing the well data of the target well can include performing temporal and spatial information normalization on the well data of the target well, and temporal and spatial information normalization on the well data of the existing wells can be performed before training the AI network.

The target well can be a well to be drilled, and the target well and the existing wells can be within a same reservoir.

The reservoir parameters of the target well can be determined based on the reservoir parameters of the existing wells and a geological relationship between the existing wells and the target well.

In some implementations, the reservoir parameters of the target well can be generated by the computing system using a second AI network with previously estimated well logs of the target well using the trained AI network. The second AI network can be trained based on reconciled data of second existing wells that includes reconciled well logs of the second existing wells jointly as second inputs of the second AI network and reconciled reservoir parameters of the second existing wells jointly as second outputs of the second AI network. The second AI network can include a deep feed-forward neural network.

In some implementations, the AI network includes a capsule convolutional neural network and a deep belief neural network that are interconnected with each other. The deep belief neural network can be configured to perform temporal and spatial information normalization on the well data of the target well, the capsule convolutional neural network can include a plurality of capsules and be configured to estimate jointly the multiple well logs of the target well using the plurality of capsules, and the deep belief neural network can be further configured to reconstruct capsule output data of the plurality of capsules for estimating jointly the multiple well logs of the target well.

The deep belief neural network can be configured to perform temporal and spatial information normalization on the well data of the existing wells, the capsule convolutional neural network can include a plurality of capsules and is configured to estimate jointly the multiple well logs of the existing wells using the plurality of capsules, and the deep belief neural network can be further configured to reconstruct capsule output data of the plurality of capsules for estimating jointly the multiple well logs of the existing wells. In some cases, the deep belief neural network is configured to separate the normalized well data into a plurality of normalized inputs and corresponding normalized outputs according to temporal, spatial, and type aspects, and each capsule in the capsule convolutional neural network is configured to receive one or more respective normalized inputs as input data and corresponding normalized outputs as output data.

The multiple reservoir parameters can include two or more of a list of parameters including permeability, porosity, oil saturation, water saturation, lithology, matrix density, and clay content. The multiple well logs can include two or more of a list of well logs including logs of bulk density, resistivity, velocity, gamma ray, deep induction, neutron porosity, and density porosity.

In some implementations, the method further includes: obtaining new reservoir parameters of the target well based on the estimated multiple well logs of the target well by the computing system and evaluating hydrocarbon properties of the target well based on the new reservoir parameters of the target well by the computing system. One or more of the estimated multiple well logs of the target well can be selected for actual measurement.

In some implementations, the method further includes: generating reconciled reservoir parameters of the target well by the computing system using a second AI network with the estimated multiple well logs of the target well. The second AI network can be trained based on reconciled data of second existing wells that includes reconciled well logs of the second existing wells jointly as second inputs of the second AI network and reconciled reservoir parameters of the second existing wells jointly as second outputs of the second AI network.

Another aspect of the present disclosure features a method of reconciling reservoir parameters of a target well including: obtaining well logs of the target well by a computing system and estimating jointly reservoir parameters of the target well by the computing system utilizing an artificial intelligence (AI) network with the well logs of the target well. The AI network is trained based on well data of existing wells that includes multiple reconciled reservoir parameters of the existing wells jointly as inputs of the AI network and multiple reconciled well logs of the existing wells jointly as outputs of the AI network, the estimated reservoir parameters of the target well being reconciled with each other. The estimated reservoir parameters of the target well can be reconciled with the multiple reconciled reservoir parameters of the existing wells.

The well logs of the target well can be reconciled with each other. In some implementations, the well logs of the target well are estimated by the computing system using a second AI network with well data of the target well, the well data of the target well including depth and geological information and multiple initial reservoir parameters, and the second AI network is trained based on well data of second existing wells that includes multiple reservoir parameters of the second existing wells as second inputs of the second AI network and multiple well logs of the existing wells as second outputs of the second AI network.

In some implementations, reconciled well logs of each of the existing wells are obtained by the computing system using the second AI network with well data of the existing well. The method can further include: estimating new well logs of the target well by the computing system using a second AI network with the estimated reconciled reservoir parameters of the target well, and the second AI network is trained based on well data of second existing wells that includes multiple reservoir parameters of the second existing wells as second inputs of the second AI network and multiple well logs of the existing wells as second outputs of the second AI network. The target well can be a well to be drilled, and where the target well and the second existing wells can be within a same reservoir.

The target well can be a well to be drilled, and the target well and the existing wells can be within a same reservoir. The AI network can be trained with respect to each geological body and layer, such that geological constraints and information are taken into account and adhered to the AI network.

In some implementations, the method further includes performing temporal and spatial information normalization on the well logs of the target well, and temporal and spatial information normalization on the well data of the existing wells are performed before training the AI network.

Implementations of the above techniques include methods, systems, computer program products and computer-readable media. In one example, a method can be performed by at least one processor coupled to at least one non-volatile memory and the methods can include the above-described actions. In another example, one such computer program product is suitably embodied in a non-transitory machine-readable medium that stores instructions executable by one or more processors. The instructions are configured to cause the one or more processors to perform the above-described actions. One such computer-readable medium stores instructions that, when executed by one or more processors, are configured to cause the one or more processors to perform the above-described actions.

The details of one or more implementations of the subject matter of this specification are set forth in the accompanying drawings and associated description. Other features, aspects, and advantages of the subject matter will become apparent from the description, the drawings, and the claims.

### DESCRIPTION OF DRAWINGS

FIG. 1 is a schematic diagram illustrating an example of forecasting well logs for new wells based on an artificial intelligence network.

FIG. 2 is a schematic diagram illustrating an example of an artificial intelligence network for well log training and forecasting.

FIG. 3 is a schematic diagram illustrating an example of designating a new well in a reservoir having multiple wells.

FIGS. 4A-4B show porosity (4A) and bulk density (4B) well logs of an artificial intelligence network's prediction vs. actual measurement of a sample well.

FIG. 5 is a schematic diagram illustrating an example of reconciling reservoir parameters based on an artificial intelligence network.

FIGS. 6A-6B show reconciled reservoir parameters matrix density (6A) and water saturation (6B) of an artificial intelligence network's prediction vs. actual measurement of a sample well.

FIG. 7A is a flowchart of an example process of forecasting well logs with an artificial intelligence network.

FIG. 7B is a flowchart of an example process of reconciling reservoir parameters with an artificial intelligence network.

### DETAILED DESCRIPTION

Implementations of the present specification provide methods of forecasting well logs (or survey data) for newly planned wells (or newly to-be-drilled wells). The methods employ an artificial intelligence technique for estimating the well log properties from existing well log data, e.g., well logs of other drilled wells in a same (or similar) reservoir. Well logs measured in different time frames can be normalized, e.g., according to fluid distribution changes inside the reservoirs. The data driven approach of the methods can enable to accurately estimate well log responses in the newly planned wells and ensure consistency with previously collected well logs.

In some implementations, the existing well log data and geological information are first processed into a training set. The training set can include depth and geological information and reservoir parameters of the existing wells as input parameters and well logs of the existing wells as the target parameters. The reservoir parameters can include permeability, porosity, oil saturation, water saturation, lithology, matrix density, and/or clay content. The well logs can include logs of bulk density, resistivity, velocity, gamma ray, deep induction, neutron porosity, and/or density porosity. The methods can then subsequently train an artificial intelligence (AI) network, e.g., a coupled deep brief and capsule convolutional neural network, with respect to the training set, and return a trained network. The trained network can be then used together with the depth and geological information as well as assumed reservoir properties of a newly planned well to estimate jointly multiple well logs of the newly planned well at a new specified location based on the geological formation. The estimated well logs can be in consistency or reconciliation with the existing well logs. That is, the well logs that are separately interpreted, collected, and/or obtained for the various wells can be reconciled and be in agreement with each other. The reconciliation within the artificial neural network ensures consistency of all the well logs between each other and the geological formation. Therefore, the framework can use both spatial, geological settings, stratigraphic layering, and temporal properties to adjust intelligently to accurately estimate the forecasted well logs in the newly planned well and to ensure consistency with previously collected well logs.

The methods enable joint estimation of well log responses for areas where there is currently no well logs acquired. The joint estimation of the well log responses can be obtained by training the AI network based on the available well logs, and underlying geological formation. The methods can avoid inconsistencies due to deriving reservoir parameters individually or superimposing a mathematical relationship with estimated or assumed parameters. The methods can use the AI network to have an approximate expectation (or forecasting) of joint well log responses and hence better justify and determine which well logs may be of interest to be conducted. Accordingly, the methods can allow to reduce the number of logs to be conducted and/or improve the interpretation of the existing data, which can optimize the costs and improve the quality and efficiency of the formation evaluation process. The methods can support well log analysts via efficiently and quickly allowing them to reconcile the well log derived reservoir properties and then provide their interpretation. The AI network can be configured to be flexible to learn new information and be updated based on the new information. Thus, the more well logs are available for training, the more accurate the forecasting of the well logs and/or reservoir parameters for a newly planned well in the same or similar reservoir can be.

Implementations of the present specification also provide methods of reconciling reservoir parameters using artificial intelligence, e.g., an artificial neural network. The methods can have well log data (e.g., jointly reconciled well logs) as inputs and then subsequently reconcile petrophysical parameters as outputs with the artificial intelligence. The joint reconciliation of the well logs can ensure that the output petrophysical parameters (e.g., water saturation, oil saturation, and/or porosity) conform well to the input well logs (e.g., velocity, resistivity, and/or bulk density) and are consistent with each other. The reconciled petrophysical parameters can be further used to predict indirect interpreted well logs (e.g., of a target well to be drilled).

In some implementations, the methods first process the well log data in a known area (e.g., of multiple existing wells in a reservoir), and create a training set. The methods can then subsequently train an artificial intelligence (AI) network with respect to the training set and return a trained network. The trained network can link the input well logs to the petrophysical parameters. The methods can then utilize the trained network for the joint reconciliation of well log data in an unknown area (e.g., a well to be drilled in the same or similar reservoir), which can create consistent petrophysical parameters for the estimation of indirectly interpreted logs.

The methods can avoid inconsistent petrophysical parameters for different well logs due to separate interpretation and inversion of the well logs, and can allow to jointly reconcile the petrophysical parameters with the well logs. The methods also allow for the continuous improvement of the trained network for newly available well logs and reconciled petrophysical parameters. The more well logs are available, the better can be the joint reconciliation of the reservoir parameters for the same or similar reservoir. The methods can enable fast and efficient well log reconciliation and avoid human biases as the methods solely uses the well log data. The methods can support well log analysts via efficiently and quickly allowing them to reconcile the well log derived reservoir properties and then provide their interpretation.

Using an analytical approach (e.g., Arche's law) to derive reservoir properties (e.g., water or oil saturation) from log measurements (e.g., resistivity) can have a key limitation that a problem is ill posed, as there is no possibility to measure downhole all the required parameters (e.g., water salinity distribution, cementation factor, or saturation exponent). In comparison, in the present specification, the AI based joint well log reconciliation can utilize the well log data directly and do not superimpose other assumptions or that may be conflicting or incorrect, thereby the methods utilizing the AI approach can overcome the key limitation and mitigate a bias induced by unknown parameters.

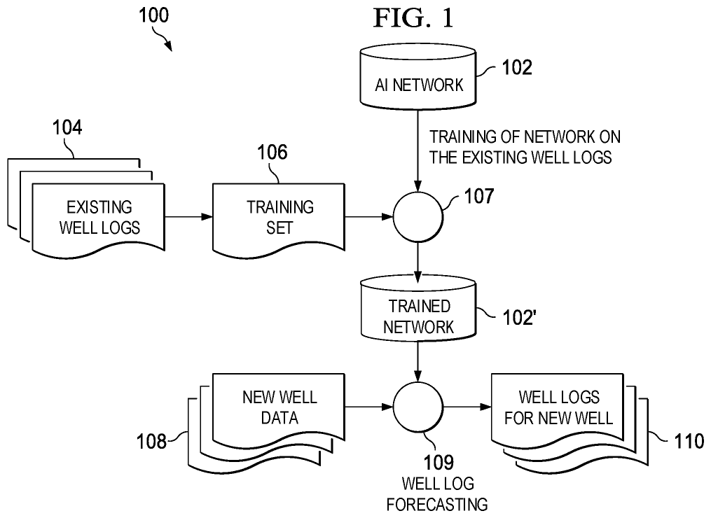

FIG. 1 is a schematic diagram illustrating an example 100 of forecasting well logs for new wells based on training an artificial intelligence (AI) network. The forecasting can be implemented by a computing system that can include one or more computing devices and one or more machine-readable repositories or databases that are in communication with each other. The databases can store existing well logs, well location data of drilled wells in one or more hydrocarbon reservoirs, geological reservoir data, reservoir properties, and/or measurement data of the drilled wells. The computing system can use both spatial, geological settings, stratigraphic layering, and temporal properties to adjust intelligently to accurately estimate well logs in the new wells and to ensure consistency with the existing well logs.

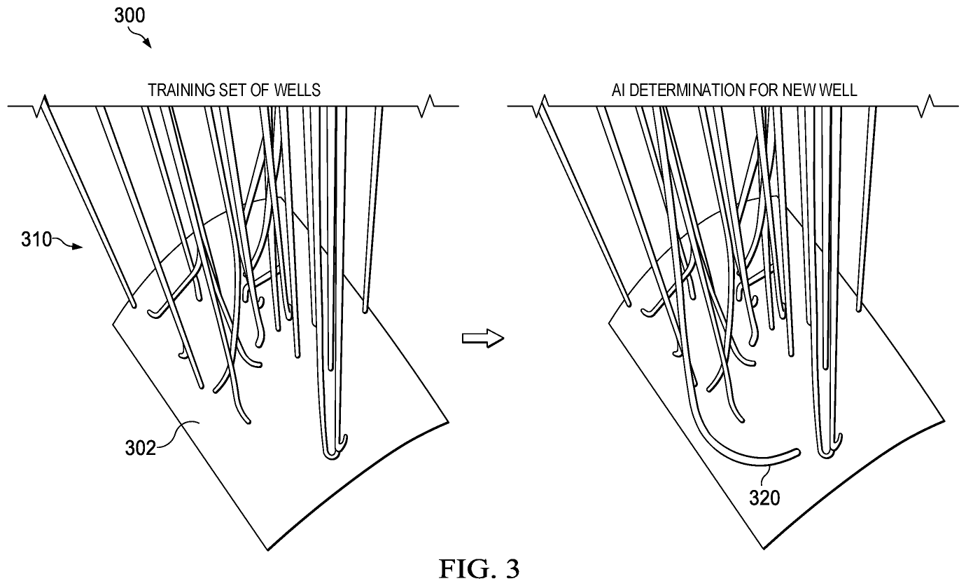

FIG. 3 shows an example 300 of designating a new well 320 in a hydrocarbon reservoir 302 where multiple existing wells 310 can be previously drilled or formed. Each well 310 can be a borehole extending from a terranean surface (or the Earth's surface) to a respective subterranean zone of interest in the reservoir 302. The well 310 can be any suitable type of well, e.g., a well including a single wellbore or a well including multiple wellbores. The well 310 can be configured to produce hydrocarbon components, e.g., gas, oil, water, or any suitable combinations, from the respective subterranean zone in the reservoir 302. The wells 312 can be made at different times, e.g., with a difference of 5 years, 10 years, 20 years, 30 years, or 50 years, and their well logs of the wells 312 can be temporally and spatially distributed among a wide time range.

The new well 320 can be a candidate well for drilling in the reservoir 302. An operator can first forecast or estimate well log responses of one or more candidate wells, then derive petrophysical parameters from the forecasted well log responses, and finally select one of the one or more candidate wells with a desired (or suitable) performance (or object) (e.g., high hydrocarbon productivity) and/or better performance than other candidate wells. The well logs of each candidate well can be forecasted as described in FIG. 1. Depending on the objective of the operator, the computing system may conduct certain well logs and can utilize the information of the well logs in retraining the AI network 102.

Referring back to FIG. 1, well log data of existing wells, including existing well logs 104, e.g., of the existing wells 310 in the reservoir 302 of FIG. 3, depth and geological information, e.g., of the existing wells 310 of FIG. 3, and reservoir parameters, e.g., of the existing wells 310 of FIG. 3, can be first processed into a training set 106. For example, the well log data can be filtered with a linear smoothing filter to remove outliers and artifacts in the data. The filter window size may either be chosen manually or be a fixed percentage of the overall data length. The training set 106 may also be visually inspected for erroneous artifacts. The processed data are then categorized, and may be reduced further if desired. Finally, the data are separated into input parameters and output (or target) parameters for the training. The training set 106 can include the depth and geological information and the reservoir parameters of the existing wells as input parameters and the multiple well logs of the existing wells jointly as output (or target) parameters. The reservoir parameters can include permeability, porosity, oil saturation, water saturation, lithology, matrix density, and/or clay content. The well logs can include logs of bulk density, resistivity, velocity, gamma ray, deep induction, neutron porosity, and/or density porosity. Instead of using just one well log as the output parameter, the computing system can train the AI network 102 to simultaneously output multiple joint well logs.

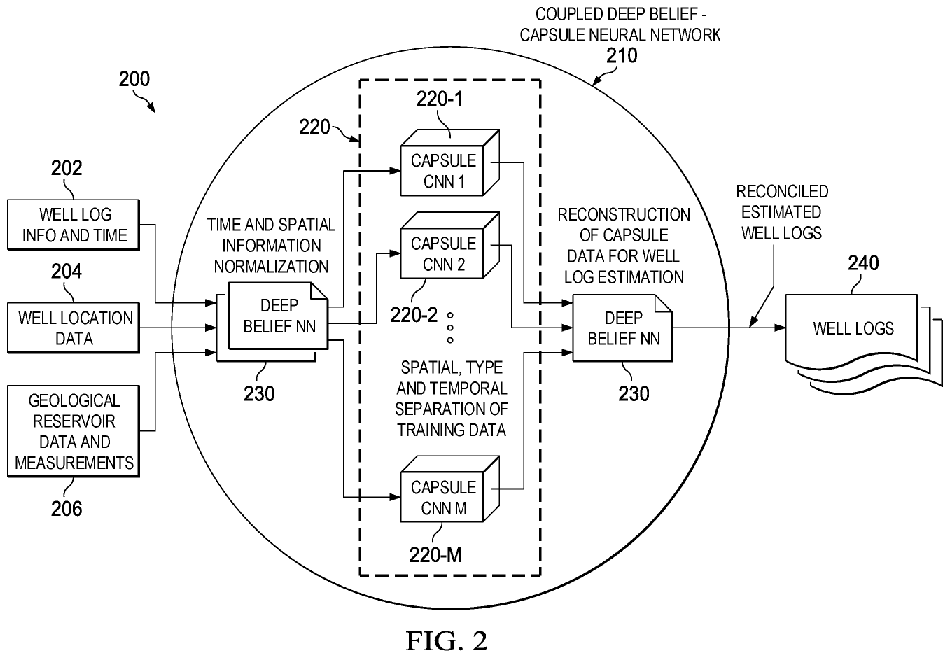

The computing system can train an artificial intelligence (AI) network 102 with respect to the training set 106 at a processing step 107 and return a trained network 102′. In some examples, the AI network 102 can be an artificial neural network, e.g., as illustrated with details in FIG. 2. At a processing step 109, the computing system can use the trained network 102′ together with new well data 108 of a newly planned well to jointly forecast multiple well logs 110 in the newly planned well at a new specified location, e.g., the new well 320 of FIG. 3. The forecasted multiple well logs are consistent or reconciled with each other, because they are optimized at the same time. In this way, inconsistencies due to deriving reservoir parameters individually or superimposing a mathematical relationship with estimated or assumed parameters can be avoided.

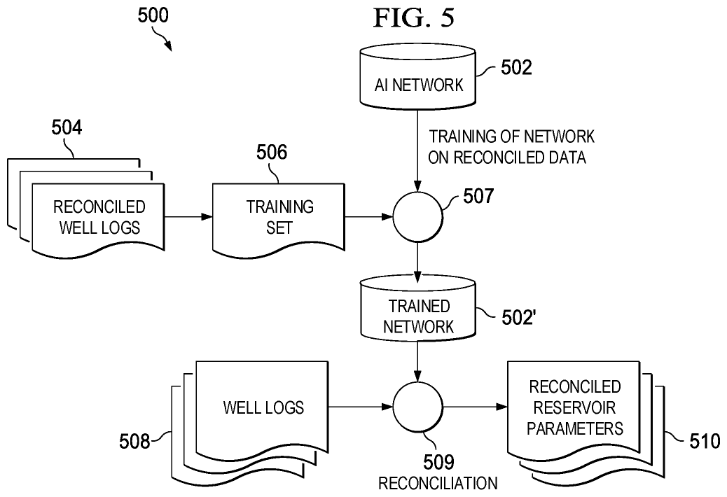

The new well data 108 can be conformed with respect to information of the existing wells as the training set 106. For example, the new well data 108 can include depth and geological information of the newly planned well that can be obtained based on the spatial relationship between the existing wells and the newly planned well, as illustrated in FIG. 3. The new well data 108 can also include estimated (or assumed) reservoir properties or petrophysical parameters. For example, the estimated petrophysical parameters can be based on the known petrophysical parameters of the existing wells and/or the reservoir. As discussed with further details in FIG. 5, the known petrophysical parameters can be reconciled petrophysical parameters based on reconciled well logs of the existing wells. In some cases, the estimated petrophysical parameters can be reconciled petrophysical parameters derived based on reconciled and estimated well logs of the newly planned well, e.g., the well logs 110 in a previous forecasting or estimation using the trained network 102′.

The forecasted well logs 110 for the new well can be in consistency or reconciliation with the existing well logs 104. That is, the well logs 110 of the new well and the existing well logs 104 are reconciled well logs. In some implementations, the trained network 102′ can be used to obtain reconciled well logs for existing wells, e.g., by replacing the new well data 108 with well data of the existing wells at the processing step 109. The reconciled well logs of the existing wells can be used for generating reconciled reservoir parameters, as discussed with further details in FIG. 5.

FIG. 2 is a schematic diagram illustrating an example 200 of an artificial intelligence (AI) network 210 for well log training and forecasting. The AI network 210 can be the AI network 102 of FIG. 1. In some implementations, as shown in FIG. 2, the AI network 210 can be an integrated (or interconnected) network coupling a capsule convolutional neural network (capsule CNN) 220 and a deep belief neural network (deep belief NN) 230. The capsule CNN 220 is the main network and is interconnected with the deep belief neural network 230. The deep belief neural network 230 can be configured to perform temporal and spatial normalization on well data. The deep belief neural network 230 can also be configured to ensure that with the spatial sparsity of the training data, the initial weights of the capsule CNN 220 are better initially estimated. The capsule CNN 220 can be configured to estimate much more robust the multiple reconciled well logs. The capsule CNN 220 can estimate spatial differences of the multiple reconciled well logs, and the deep belief neural network 230 can strengthen the reconciliation and estimation of the multiple well logs in time.

During training the network 210, the deep belief neural network 230 can first receive information of existing wells and/or reservoir, e.g., the existing wells 310 and/or the reservoir 302 of FIG. 3. The information of the existing wells and/or reservoir can include well log data 202 (e.g., well log information and time) of existing wells, well location data 204, and/or geological reservoir data and measurement data 206 (e.g., depth and geological information and reservoir properties such as petrophysical parameters of the existing wells). The deep belief neural network 230 can be configured to perform temporal and/or spatial information normalization on the received information of the existing wells to ensure that various well logs measured at different times and/or at different locations are normalized to a desired time and/or location, depending on the formation structure of the reservoir, according to fluid distribution changes inside the reservoirs, and/or to ensure that the well logs are reconciled in time and/or location as well.

The normalized information of the existing wells can be considered as training data for the capsule CNN 220, where the depth and geological information and reservoir properties can be considered as input parameters and the well logs of the existing wells can be considered as output parameters. Each of the input parameters can be assigned with a respective weight. The respective weights can be customized or determined based on experience data. The respective weights can be initialized, e.g., randomly and/or automatically, at the beginning of the training. The respective weights can be continuously updated during the training process.

The capsule CNN 220 can be separated into multiple capsules 220-1, 220-2, . . . , 220-M, that allow to take into account a hierarchical nature and composition of a reservoir structure. Each capsule can have a CNN structure that can include a series of convolution layers and activation functions between adjacent convolution layers. The capsules can be independent from each other. When multiple capsules agree, the probability of correct estimation is much higher. Each capsule can receive respective training data, e.g., spatial, type and temporal separated training data, and generate respective output parameters. The spatial, type and temporal normalized data are then separated into a plurality of capsules where each capsule obtains the normalized well data separated according to time and spatial as well as type aspects. The capsule's output data are the corresponding normalized target well log data.

The capsule output data, e.g., the respective output parameters from the capsules 220-1, 220-2, . . . , 220-M, of the capsule CNN 220 can be received by the deep belief neural network 230 that can be configured to reconstruct the capsule output data for estimating multiple joint and reconciled well logs 240. The well logs 240 can be fed back as the well log data 202 to optimize the AI network 210.

After the AI network 210 is trained, new well data of a newly planned well can be provided to the trained AI network 210. The newly planned well can be in the same or similar reservoir as the existing wells. The new well data can be the new well data 108 of FIG. 1, and can include depth and geological information of the newly planned well and estimated (or assumed) reservoir properties or petrophysical parameters. The new well data can be conformed (or processed) with respect to the information of existing wells and/or reservoir as the training set, e.g., normalized by the deep belief neural network 230. Then the trained AI network 210 can estimate jointly multiple well logs 240 based on the new well data for the newly planned well. The multiple well logs 240 can be reconciled with each other and with well logs of the existing wells.

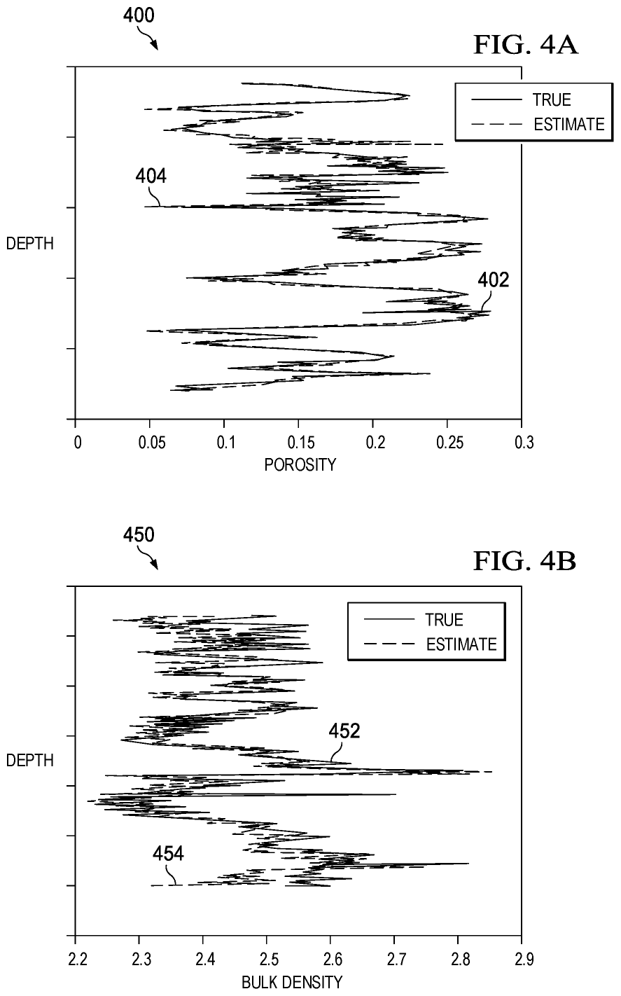

FIGS. 4A-4B show porosity (4A) and bulk density (4B) well logs of an artificial intelligence (AI) network's prediction vs. actual measurement on a sample well. The porosity and bulk density well logs of the AI network's prediction are joint well logs estimated by the same trained AI network, e.g., the AI network 102′ of FIG. 1 or the AI network 210 of FIG. 2. As shown in diagram 400 of FIG. 4A, curve 402 represents the true porosity well log by actual measurement and curve 404 represents the estimated porosity well log that matches well with curve 402. As shown in diagram 450 of FIG. 4B, curve 452 represents the true bulk density well log by actual measurement and curve 454 represents the estimated bulk density well log that matches well with curve 452. The matching results for joint porosity and bulk density well logs indicate strong reconciliation and forecasting quality.

FIG. 5 is a schematic diagram illustrating an example 500 of reconciling reservoir parameters using an artificial intelligence (AI) network 502. The reconciling can be implemented by a computing system that can include one or more computing devices and one or more machine-readable repositories or databases that are in communication with each other. The computing system can be the computing system for performing well logs forecasting in FIG. 1. The AI network 502 can be an artificial neural network. In some examples, the AI network 502 can be an integrated network coupling a capsule convolutional neural network and a deep belief neural network, similar to the AI network 210 of FIG. 2. In some examples, the AI network 502 is composed of deep feed-forward neural network that is trained on the reconciled training data.

The computing system is configured to obtain reconciled reservoir parameters of a target well from reconciled well logs of the target well by using the AI network. The target well can be a drilled well, a well to be drilled, or a candidate well for drilling. The computing system can first prepare reconciled well logs 504 that are used for a training set 506.

The reconciled well logs 504 can include multiple well logs from existing wells in a reservoir same as the target well. The term “reconciled well logs” indicates that the well logs are reconciled and put in agreement with each other and can be consistently interpreted temporally and spatially. In some examples, as discussed above, the reconciled well logs 504 of the existing wells can be prepared by using the trained network 102′ of FIG. 1, e.g., by replacing the new well data 108 with well data of the existing wells at the processing step 109. In some examples, the reconciled well logs 504 of the existing wells can be prepared manually, e.g., by checking that the well logs are reconciled and consistent with each other.

The training set 506 also includes reconciled reservoir parameters (e.g., water saturation, oil saturation, and/or porosity) of the existing wells that correspond to the reconciled well logs 504. The term “reconciled reservoir parameters” indicates that the reservoir parameters reconciled and put in agreement with each other and can be consistently interpreted temporally and spatially. In some examples, the reconciled reservoir parameters can be prepared by actual measurements for the existing wells. In some examples, the reconciled reservoir parameters can be prepared manually, e.g., by checking that the reservoir parameters are reconciled and consistent with each other without conflict.

The computing system can use the reconciled well logs 504 as input parameters and the reconciled reservoir parameters as output parameters and train the AI network 502 on the training set at a processing step 507 until a desired training performance is met to return a trained network 502′. The trained network 502′ can link the input reconciled well logs to the reconciled reservoir parameters.

In some implementations, the AI network 502 is trained with respect to each geological body and layer, which ensures that geological constraints and information is taken into account and adhered to. Additionally, temporal changes in the reservoir between the well logs can be also taken into account, as logs acquired in different times can reflect different fluid distribution scenario inside the reservoir. In some implementations, a deep belief neural network, e.g., the deep belief NN 230 of FIG. 2, can be configured to perform temporal and/or spatial information normalization on the reconciled well logs 504 of the existing wells to ensure that various well logs measured at different times are normalized to a desired time.

At a processing step 509, the computing system can use the trained network 502′ together with well logs of the target well for reconciliation to generate reconciled reservoir parameters (or reservoir properties) 510. The well logs of the target well can be conformed to those types of the well logs 504 used for training the AI network 502. The well logs can be reconciled with each other and/or with the well logs of the existing wells. The reservoir parameters are reconciled or consistent with each other, because they are optimized at the same time.

In some examples, the target well is a drilled well or an existing well, and the well logs of the target well can be obtained by actual measurements. The reconciled reservoir parameters 510 can be further used for evaluation of hydrocarbon properties of the target well, and/or for training the AI network 102 of FIG. 1 and for estimating or forecasting unknown well logs of wells to be drilled. In some examples, the target well is a well to be drilled or a candidate well for drilling, and the well logs of the target well can be obtained by using the trained network 102′ of FIG. 1, e.g., by inputting the well data of the target well into the trained network 102′ to get estimated and reconciled joint well logs. The reconciled reservoir parameters 510 can be further used as part of the new well data 108 to further estimate the joint well logs of the target well, and/or used for evaluation of hydrocarbon properties of the target well.

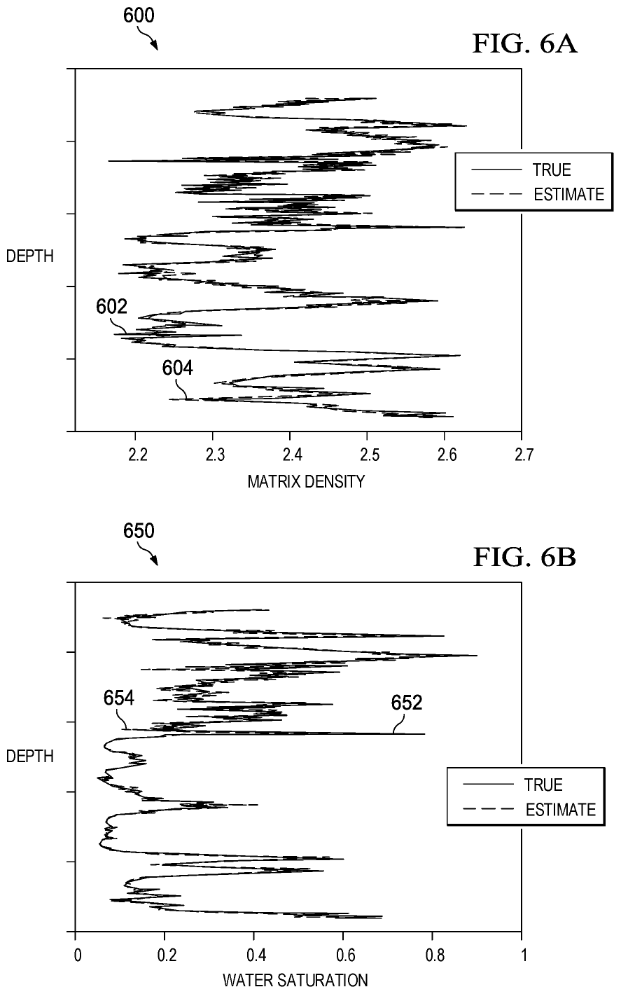

FIGS. 6A-6B show reconciled reservoir parameters: matrix density (6A) and water saturation (6B) of an artificial intelligence (AI) network's prediction vs. actual measurement on a sample well. The matrix density and water saturation profiles of the AI network's prediction are joint reservoir parameters reconciled by the same trained AI network, e.g., the AI network 502′ of FIG. 5. As shown in diagram 600 of FIG. 6A, curve 602 represents the true matrix density by actual measurement and curve 604 represents the estimated matrix density parameter that matches well with curve 602. As shown in diagram 650 of FIG. 6B, curve 652 represents the true water saturation by actual measurement and curve 654 represents the estimated water saturation that matches well with curve 652. The matching results for joint matrix density and water saturation parameters indicate accurate reconciliation from the well logs.

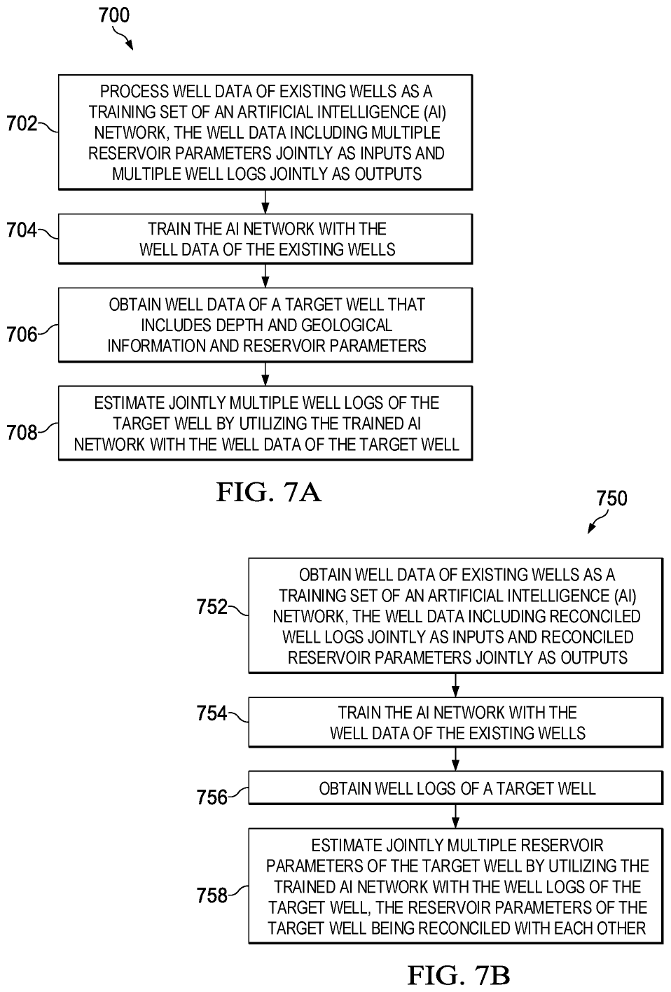

FIG. 7A is a flowchart of an example process 700 of forecasting well logs with an artificial intelligence network. The process 700 can be performed by a computing system. The computing system can be the computing system of FIG. 1 and can include one or more computing devices and one or more machine-readable repositories or databases that are in communication with each other.

At 702, well data of existing wells is processed as a training set of an artificial intelligence (AI) network. The well data of the existing wells includes multiple reservoir parameters jointly as input parameters of the AI network and multiple well logs jointly as output parameters of the AI network. The multiple reservoir parameters can include two or more of a list of parameters including permeability, porosity, oil saturation, water saturation, lithology, matrix density, and clay content. The multiple well logs can include two or more of a list of well logs including logs of bulk density, resistivity, velocity, gamma ray, deep induction, neutron porosity, and density porosity.

In some examples, the AI network is an artificial neural network. For example, as illustrated in FIG. 2, the AI network can be an integrated network including a capsule convolutional neural network and a deep belief neural network that are interconnected with each other. The deep belief neural network is configured to process the well data of the existing wells by performing temporal and spatial information normalization on the well data of the existing wells.

At 704, the AI network is trained with the well data of the existing wells. Each of the input parameters can be assigned with a respective weight. The respective weights can be customized or determined based on experience data or initialized, e.g., randomly and/or automatically, at the beginning of the training. The respective weights can be continuously updated during the training process. For example, the capsule convolutional neural network can include a plurality of capsules independent from each other and can estimate jointly the multiple well logs of the existing wells using the plurality of capsules. The deep belief neural network can reconstruct capsule output data of the plurality of capsules for estimating jointly the multiple well logs of the existing wells. Then the estimated well logs of the existing wells can be compared with the well logs of the existing wells. The AI network, e.g., the respective weights of the input parameters, can be adjusted for optimization based on a result of the comparison.

At 706, well data of a target well is obtained. The well data of the target well includes depth and geological information and initial reservoir parameters. The initial reservoir parameters can include one or more of a list of parameters including permeability, porosity, oil saturation, water saturation, lithology, matrix density, and clay content. The target well can be a well to be drilled, and the target well and the existing wells can be in the same reservoir.

In some examples, the initial reservoir parameters of the target well can be determined based on the reservoir parameters of the existing wells and a geological relationship between the existing wells and the target well. In some examples, the reservoir parameters of the target well are generated using a second AI network with previously estimated well logs of the target well using the trained AI network, as described with details in FIG. 7B. The second AI network is trained based on reconciled data of second existing wells that includes reconciled well logs of the second existing wells jointly as inputs of the second AI network and reconciled reservoir parameters of the second existing wells jointly as outputs of the second AI network. The second AI network can have a same network structure as the AI network.

In some implementations, the well data of the target well is processed to be conformed with the well data of the existing wells. Processing the well data of the target well can include performing temporal and spatial information normalization on the well data of the target well, e.g., by using the deep belief neural network in the AI network.

At 708, multiple well logs of the target well are jointly estimated by utilizing the trained AI network with the well data of the target well. The estimated multiple well logs of the target well are reconciled with each other. The estimated multiple well logs of the target well can include two or more of a list of well logs including logs of bulk density, resistivity, velocity, gamma ray, deep induction, neutron porosity, and density porosity. The estimated multiple well logs of the target well can be reconciled with the multiple well logs of the existing wells and geographic formation associated with the target well and the existing wells. One or more of the estimated multiple well logs of the target well can be selected for actual measurement.

The process 700 can further include obtaining new reservoir parameters of the target well based on the estimated multiple well logs of the target well and evaluating hydrocarbon properties of the target well based on the new reservoir parameters of the target well and/or the estimated multiple well logs of the target well.

In some implementations, the estimated and reconciled well logs of the target well can be further used to generate reconciled reservoir parameters of the target well by using the second AI network, as discussed with further details in FIG. 7B.

FIG. 7B is a flowchart of an example process 750 of reconciling reservoir parameters with an artificial intelligence (AI) network. The process 750 can be performed by a computing system, e.g., the computing system of FIG. 5. The computing system can be the same as the computing system in FIG. 1 or FIG. 7A. The AI network can be the AI network 502 of FIG. 5.

At 752, well data of existing wells is obtained as a training set of the AI network. The well data including reconciled well logs of the existing wells jointly as inputs of the AI network and reconciled reservoir parameters of the existing wells jointly as outputs of the AI network.

In some examples, the reconciled well logs of the existing wells can be prepared by using a second AI network, e.g., the trained AI network 102′ of FIG. 1. In some examples, the reconciled well logs of the existing wells can be prepared manually, e.g., by checking that the well logs are reconciled and consistent with each other. In some examples, the reconciled reservoir parameters of the existing wells can be obtained by actual measurements for the existing wells. In some examples, the reconciled reservoir parameters of the existing wells can be prepared manually, e.g., by checking that the reservoir parameters are reconciled and consistent with each other without conflict.

In some implementations, a deep belief neural network, e.g., the deep belief NN 230 of FIG. 2, can be configured to perform temporal and/or spatial information normalization on the reconciled well logs of the existing wells to ensure that various well logs measured at different times and/or locations are normalized to a desired time and/or location.

At 754, the AI network is trained with the well data of the existing wells. The AI network can be trained with respect to each geological body and layer, such that geological constraints and information are taken into account and adhered to the AI network. The AI network can be trained on the training set until a desired training performance is met to return a trained network. The trained network can link the input reconciled well logs to the output reconciled reservoir parameters.

At 756, well logs of a target well is obtained. The target well can be a well to be drilled, and the target well and the existing wells can be within a same reservoir. The well logs of the target well can be conformed to those types of the reconciled well logs of the existing wells used for training the AI network. For example, the well logs of the target well can be normalized temporally and spatially, e.g., by using a deep belief neural network, to be consistent with the reconciled well logs of the existing wells.

The well logs of the target well can be reconciled with each other. In some examples, the well logs of the target well can be estimated, e.g., by the process 700 of FIG. 7A, using a second AI network with well data of the target well including depth and geological information and multiple initial reservoir parameters. The second AI network can be trained based on well data of second existing wells that includes multiple reservoir parameters of the second existing wells as inputs of the second AI network and multiple well logs of the existing wells as outputs of the second AI network. The second AI network can be the AI network 102 of FIG. 1, the AI network 210 of FIG. 2, or the AI network of FIG. 7A. The second AI network can have the same network structure as the AI network.

At 758, multiple reservoir parameters of the target well are jointly estimated by utilizing the trained AI network with the well logs of the target well. The multiple reservoir parameters of the target well are reconciled with each other, with the multiple reconciled reservoir parameters of the existing wells, and/or with a geographic formation associated with the target well and the existing wells.

The multiple estimated and reconciled reservoir parameters of the target well can be used to estimate new well logs of the target well using the second AI network, as discussed in the process 700 of FIG. 7A.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, such as, one or more modules of computer program instructions encoded on a tangible, non-transitory computer-storage medium for execution by, or to control the operation of, data processing apparatus. Alternatively or in addition, the program instructions can be encoded on an artificially generated propagated signal, such as, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus and special purpose logic circuitry may be hardware-based and software-based. The apparatus can optionally include code that creates an execution environment for computer programs, for example, code that constitutes processor firmware, a protocol stack, a database management system, an operating system, or a combination of one or more of them. The present specification contemplates the use of data processing apparatuses with or without conventional operating systems.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD-R, DVD-RAM, and DVD-ROM disks. The memory may store various objects or data, including caches, classes, frameworks, applications, backup data, jobs, web pages, web page templates, database tables, repositories storing business and dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include multiple user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a web browser through which a user can interact with an implementation of the subject matter described in this specification, or any combination of one or more such back-end, middleware, or front-end components. The components of the system can be interconnected by any form or medium of wireline or wireless digital data communication, for example, a communication network. Examples of communication networks include a local area network (LAN), a radio access network (RAN), a metropolitan area network (MAN), a wide area network (WAN), worldwide interoperability for microwave access (WIMAX), a wireless local area network (WLAN) using, for example, 902.11 a/b/g/n and 902.20, all or a portion of the Internet, and any other communication system or systems at one or more locations. The network may communicate with, for example, internet protocol (IP) packets, frame relay frames, asynchronous transfer mode (ATM) cells, voice, video, data, or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and software, may interface with each other or the interface using an application programming interface (API) or a service layer. The API may include specifications for routines, data structures, and object classes. The API may be either computer language-independent or -dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in any suitable language providing data in any suitable format. The API and service layer may be an integral or a stand-alone component in relation to other components of the computing system. Moreover, any or all parts of the service layer may be implemented as child or sub-modules of another software module, enterprise application, or hardware module without departing from the scope of this specification.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing may be advantageous and performed as deemed appropriate.

Moreover, the separation or integration of various system modules and components in the implementations described earlier should not be understood as requiring such separation or integration in all implementations, and it should be understood that the described program components and systems can generally be integrated together in a single software product or packaged into multiple software products.

Accordingly, the earlier provided description of example implementations does not define or constrain this specification. Other changes, substitutions, and alterations are also possible without departing from the spirit and scope of this specification.

What is claimed is:

1. A method of forecasting well logs of a target well, the method comprising:
obtaining well data of the target well by a computing system, the well data comprising depth and geological information and multiple reservoir parameters; and
estimating jointly multiple well logs of the target well by the computing system utilizing an artificial intelligence (AI) network with the well data of the target well, the AI network being trained based on well data of existing wells that comprises multiple reservoir parameters of the existing wells jointly as inputs of the AI network and multiple well logs of the existing wells jointly as outputs of the AI network, the estimated multiple well logs of the target well being reconciled with each other.

2. The method of claim 1, wherein the estimated multiple well logs of the target well are reconciled with the multiple well logs of the existing wells and geographic formation associated with the target well and the existing wells.

3. The method of claim 1, further comprising:
processing the well data of the target well to be conformed with the well data of the existing wells.

4. The method of claim 3, wherein processing the well data of the target well comprises:
performing temporal and spatial information normalization on the well data of the target well,
wherein temporal and spatial information normalization on the well data of the existing wells are performed before training the AI network.

5. The method of claim 1, wherein the target well is a well to be drilled, and wherein the target well and the existing wells are within a same reservoir.

6. The method of claim 1, wherein the reservoir parameters of the target well are determined based on the reservoir parameters of the existing wells and a geological relationship between the existing wells and the target well.

7. The method of claim 1, wherein the reservoir parameters of the target well are generated by the computing system using a second AI network with previously estimated well logs of the target well using the trained AI network.

8. The method of claim 7, wherein the second AI network is trained based on reconciled data of second existing wells that comprises reconciled well logs of the second existing wells jointly as second inputs of the second AI network and reconciled reservoir parameters of the second existing wells jointly as second outputs of the second AI network.

9. The method of claim 7, wherein the second AI network comprises a deep feed-forward neural network.

10. The method of claim 1, wherein the AI network comprises a capsule convolutional neural network and a deep belief neural network that are interconnected with each other.

11. The method of claim 10, wherein the deep belief neural network is configured to perform temporal and spatial information normalization on the well data of the target well,
wherein the capsule convolutional neural network comprises a plurality of capsules and is configured to estimate jointly the multiple well logs of the target well using the plurality of capsules, and
wherein the deep belief neural network is configured to reconstruct capsule output data of the plurality of capsules for estimating jointly the multiple well logs of the target well.

12. The method of claim 10, wherein the deep belief neural network is configured to perform temporal and spatial information normalization on the well data of the existing wells,
wherein the capsule convolutional neural network comprises a plurality of capsules and is configured to estimate jointly the multiple well logs of the existing wells using the plurality of capsules, and
wherein the deep belief neural network is further configured to reconstruct capsule output data of the plurality of capsules for estimating jointly the multiple well logs of the existing wells.

13. The method of claim 12, wherein the deep belief neural network is configured to separate the normalized well data into a plurality of normalized inputs and corresponding normalized outputs according to temporal, spatial, and type aspects, and
wherein each capsule in the capsule convolutional neural network is configured to receive one or more respective normalized inputs as input data and corresponding normalized outputs as output data.

14. The method of claim 1, wherein the multiple reservoir parameters comprise two or more of a list of parameters comprising permeability, porosity, oil saturation, water saturation, lithology, matrix density, and clay content.

15. The method of claim 1, wherein the multiple well logs comprise two or more of a list of well logs comprising logs of bulk density, resistivity, velocity, gamma ray, deep induction, neutron porosity, and density porosity.

16. The method of claim 1, further comprising:
obtaining new reservoir parameters of the target well based on the estimated multiple well logs of the target well by the computing system; and
evaluating hydrocarbon properties of the target well based on the new reservoir parameters of the target well by the computing system.

17. The method of claim 1, further comprising:
generating reconciled reservoir parameters of the target well by the computing system using a second AI network with the estimated multiple well logs of the target well,
wherein the second AI network is trained based on reconciled data of second existing wells that comprises reconciled well logs of the second existing wells jointly as second inputs of the second AI network and reconciled reservoir parameters of the second existing wells jointly as second outputs of the second AI network.

18. The method of claim 1, wherein one or more of the estimated multiple well logs of the target well are selected for actual measurement.

19. A method of reconciling reservoir parameters of a target well, the method comprising:
obtaining well logs of the target well by a computing system; and
estimating jointly reservoir parameters of the target well by the computing system utilizing an artificial intelligence (AI) network with the well logs of the target well, the AI network being trained based on well data of existing wells that comprises multiple reconciled reservoir parameters of the existing wells jointly as inputs of the AI network and multiple reconciled well logs of the existing wells jointly as outputs of the AI network, the estimated reservoir parameters of the target well being reconciled with each other.

20. The method of claim 19, wherein the estimated reservoir parameters of the target well are reconciled with the multiple reconciled reservoir parameters of the existing wells.

21. The method of claim 19, wherein the well logs of the target well are reconciled with each other.

22. The method of claim 21, wherein the well logs of the target well are estimated by the computing system using a second AI network with well data of the target well, the well data of the target well comprising depth and geological information and multiple initial reservoir parameters, and
wherein the second AI network is trained based on well data of second existing wells that comprises multiple reservoir parameters of the second existing wells as second inputs of the second AI network and multiple well logs of the existing wells as second outputs of the second AI network.

23. The method of claim 22, wherein reconciled well logs of each of the existing wells are obtained by the computing system using the second AI network with well data of the existing well.

24. The method of claim 19, further comprising:
estimating new well logs of the target well by the computing system using a second AI network with the estimated reconciled reservoir parameters of the target well,
wherein the second AI network is trained based on well data of second existing wells that comprises multiple reservoir parameters of the second existing wells as second inputs of the second AI network and multiple well logs of the existing wells as second outputs of the second AI network.

25. The method of claim 24, wherein the target well is a well to be drilled, and wherein the target well and the second existing wells are within a same reservoir.

26. The method of claim 19, wherein the target well is a well to be drilled, and wherein the target well and the existing wells are within a same reservoir.

27. The method of claim 19, wherein the AI network is trained with respect to each geological body and layer, such that geological constraints and information are taken into account and adhered to the AI network.

28. The method of claim 19, further comprising:
performing temporal and spatial information normalization on the well logs of the target well,
wherein temporal and spatial information normalization on the well data of the existing wells are performed before training the AI network.

29. A computing system comprising:
at least one processor; and
at least one non-transitory machine readable storage medium coupled to the at least one processor having machine-executable instructions stored thereon that, when executed by the at least one processor, cause the at least one processor to perform operations comprising:
obtaining well data of a target well, the well data comprising depth and geological information and multiple reservoir parameters; and
estimating jointly multiple well logs of the target well by utilizing an artificial intelligence (AI) network with the well data of the target well, the AI network being trained based on well data of existing wells that comprises multiple reservoir parameters of the existing wells jointly as inputs of the AI network and multiple well logs of the existing wells jointly as outputs of the AI network, the estimated multiple well logs of the target well being reconciled with each other.

30. A computing system comprising:
at least one processor; and
at least one non-transitory machine readable storage medium coupled to the at least one processor having machine-executable instructions stored thereon that, when executed by the at least one processor, cause the at least one processor to perform operations comprising:
obtaining well logs of a target well; and
estimating jointly reservoir parameters of the target well by utilizing an artificial intelligence (AI) network with the well logs of the target well, the AI network being trained based on well data of existing wells that comprises multiple reconciled reservoir parameters of the existing wells jointly as inputs of the AI network and multiple reconciled well logs of the existing wells jointly as outputs of the AI network, the estimated reservoir parameters of the target well being reconciled with each other.
